(19) United States
(12) Patent Application Publication
(10) Pub. No.: US 2017/0006424 A1
(43) Pub. Date: Jan. 5, 2017

(54) WIRELESS UNDERGROUND LOCATION TRACKING

(71) Applicant: LINEAREDGE TECHNOLOGIES, LLC, Price, UT (US)

(72) Inventors: James Liin, Price, UT (US); Gregory L. Hunt, Cedaredge, CO (US)

(21) Appl. No.: 15/201,267

(22) Filed: Jul. 1, 2016

Related U.S. Application Data
(60) Provisional application No. 62/298,387, filed on Feb. 22, 2016.
(60) Provisional application No. 62/187,754, filed on Jul. 1, 2015.

(51) Int. Cl. H04W 4/02; H04W 4/00; H04L 12/26; H04L 29/12

(52) U.S. Cl. CPC H04W 4/023; H04L 61/6022; H04W 4/021; H04W 4/008; H04L 43/106

(57) ABSTRACT

Technology for a location tag transceiver configured to enable location information services is described. The location tag transceiver can receive a location information signal from a low energy fixed location beacon via a first radio access technology (RAT). The location information signal can include a media access control (MAC address) at a defined power level. The location tag transceiver can transmit, via a second RAT, the location information signal to a location server to enable the location server to: identify a fixed location perimeter of the low energy fixed location beacon based on a predetermined geographic location associated with the MAC address, and determine a location of the location tag transceiver within the fixed location perimeter based on the defined power level of the received location information signal.

### RELATED APPLICATIONS

The present application claims priority to U.S. Provisional Patent Application No. 62/187,754, filed Jul. 1, 2015 with a docket number of 3946-001.PROV and U.S. Provisional Patent Application No. 62/298,387, filed Feb. 22, 2016 with a docket number of 3946-003.PROV, each of which are hereby incorporated by reference in their entirety for all purposes.

### TECHNICAL FIELD

This disclosure relates to wireless location systems and, more particularly, to wireless underground real time tracking and location systems (RTLS).

### BACKGROUND

The increased demand for real time locating, positioning, and tracking services has motivated the evolution of low energy and low cost solutions. There are many services which currently determine user or object location but require high energy and high cost. Many of these systems use Global Positioning Systems (GPS) or other satellite and wide area network systems to locate and position users or objects. The use of such services has evolved to include positioning of users and objects in medical, retail, and even mining operations. With such high consumer demand for positioning services coupled with developments in low energy wireless personal area network technology, it is of interest to enhance the positioning service capabilities of low energy network systems and deliver high accuracy and low energy solutions, thereby ensuring ubiquitous access to locating and positioning services from any location, in any environment or application, with any device and technology.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates an example low energy fixed location beacon and an example location tag transceiver in accordance with an example;

FIG. 2 illustrates an example of a location tag transceiver and an example location server in accordance with an example;

FIGS. 3A and 3B illustrate tracking a location tag transceiver with a low energy fixed location beacon in accordance with an example;

FIG. 4A illustrates determining the position of a location tag transceiver with a low energy fixed location beacon placed along an edge of a fixed location perimeter using one or more of Bluetooth v4.0, Bluetooth Low Energy, Bluetooth v4.1, or Bluetooth v4.2 wireless communication standards in accordance with an example;

FIG. 4B illustrates determining the position of a location tag transceiver with a low energy fixed location beacon using one or more of Bluetooth v4.0, Bluetooth Low Energy, Bluetooth v4.1, or Bluetooth v4.2 wireless communication standards in accordance with an example;

FIG. 5 illustrates determining the location of a location tag transceiver based on communication between the location tag transceiver and multiple low energy fixed location beacons in accordance with an example;

FIGS. 6A and 6B illustrate determining a location tag transceiver's direction of travel based on communications between low energy fixed location beacons and the location tag transceiver in accordance with an example;

FIG. 7 illustrates a tracking system in accordance with an example;

FIG. 8 depicts a flow chart of at least one non-transitory machine readable storage medium having instructions embodied thereon for determining a location of a location tag transceiver in accordance with an example;

FIG. 9 illustrates a diagram of a mobile communication device with built-in location tag transceiver in accordance with an example; and

FIG. 10 illustrates a block diagram of a compact location tag transceiver in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

A technology is described for a wireless location system operable to locate a location tag transceiver when proximate to at least one low energy fixed location beacon. A location tag transceiver can automatically communicate its approximate position to a location server by receiving information from the proximate low energy fixed location beacon and transmitting that data to the location server. In other words, a location tag transceiver's location can be mapped by the location server based on data received from the location tag transceiver and the low energy fixed location beacon. The location of the location tag transceiver can then be determined and displayed on a map or diagram by the location server.

In one example, the location tag transceiver can receive, from a proximate low energy fixed location beacon, the proximate low energy fixed location beacon's identity. This proximate low energy fixed location beacon identity can be referred to as location information. The location information can be a media access control (MAC address). A MAC address can be defined for each low energy fixed location beacon. As a non-limiting example, a first MAC address can correspond with a first low energy fixed location beacon, and a second MAC address can correspond with a second low energy fixed location beacon. In addition, each MAC address can be associated with a separate low energy fixed location beacon.

The location tag transceiver can communicate with a low energy fixed location beacon when the location tag transceiver enters the proximate range of the low energy fixed location beacon. In other words, each low energy fixed location beacon can communicate its MAC address to the location tag transceiver. The location tag transceiver can transmit the MAC address of the low energy fixed location beacon to a location server.

The location server can store the MAC address and locations of each beacon within a defined area. For example, the location server can be pre-loaded with a map that includes sets of ordered pairs, and each ordered pair includes a position for a particular beacon plotted on the map and an associated MAC address. The server can recognize the first proximate beacon by the MAC address received from the location tag transceiver. The server can determine the position of the location tag transceiver based on the location of the first proximate beacon. The server can store a map or floorplan of the defined area. The server can plot the location of the beacons on the map. The server can plot the position of the location tag transceiver on the map relative to the location of proximate beacons.

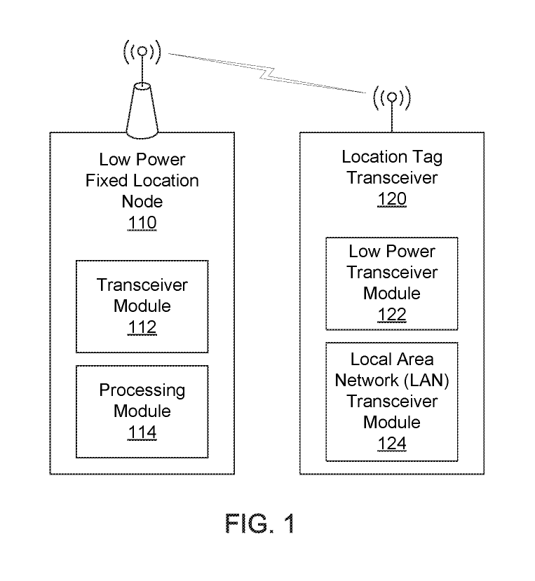

FIG. 1 illustrates an example low energy fixed location beacon 110 and an example location tag transceiver 120. The low energy fixed location beacon 110 can include a transceiver module 112 and a processing module 114. In one configuration, the low energy fixed location beacon 110 can transmit the location information signal at specified intervals from the transceiver module 110. The specified interval for broadcasting the location information signal can be from approximately 20 milliseconds to 2 minutes. By reducing the frequency of broadcasting the location information signal, the low energy fixed location beacon 110 can conserve energy. The low energy fixed location beacon 110 can include embedded sensors or can be connected to external sensors. Sensors can include barometers or other pressure sensors, thermometers or other temperature sensors, anemometer or other air flow meters, and dust sensors. Low energy fixed location beacons can be placed throughout a building, underground complex, or mine in areas in which it is desired to track persons or objects. The low energy fixed location beacons can be reference points that broadcast sensor information together with their identity.

The transceiver module 110 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, IEEE 802.16.1a-2013, WiMAX, High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11ac, or IEEE 802.11ad, or another desired wireless communication standard.

In one example, the low energy fixed location beacon 110 can broadcast a location information signal. The location information signal can be a packet of data. The location information signal can include location information and status information of the low energy fixed location beacon 110. The location information can include a name or an identity of the low energy fixed location beacon 110 used to uniquely locate the beacon on a map. The name or identity can be a media access control (MAC address). The status information can include one or more of a battery level of the low energy fixed location beacon 110, a pressure reading from a pressure sensor, temperature reading from a temperature sensor, air flow rate from an air flow meter, or dust level from a dust sensor. In one embodiment, status information can be transmitted from the low energy fixed location beacon 110 as Generic Attribute Profile (GATT) information.

The location tag transceiver 120 can include a low energy transceiver module 122 and a local area network (LAN) transceiver module 124. The low energy transceiver module 122 and the local area network (LAN) transceiver module 124 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, IEEE 802.16.1a-2013, WiMAX, Ultra High Frequency (UHF), High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11ac, or IEEE 802.11ad, or another desired wireless communication standard.

The low energy transceiver module 122 can be configured to communicate using an industrial, scientific and medical (ISM) radio band. For example, the low energy transceiver module 122 may operate at a center frequency of one or more of 2.4 GHz, 3.6 GHz, 4.9 GHz, 5 GHz, or 5.9 GHz, or another desired ISM radio band. The low energy transceiver module 122 can have a predetermined scan rate in which it receives a location information signal. An example range of the predetermined scan rate can be a predetermined scan rate from approximately once every 20 milliseconds to once every 2 minutes. The low energy transceiver module 122 can receive a location information signal from the low energy fixed location beacon 110.

In one example, the location information signal can be received by the low energy transceiver module 122 at a defined power level from the low energy fixed location beacon 110. The defined power level can be the received signal strength indicator (RSSI) value. The LAN transceiver module 124 can be configured to receive the location information signal from the low energy transceiver module 122.

In one example, the LAN transceiver module 124 can be configured to communicate using the same frequencies as the low energy transceiver module 122. The LAN transceiver module 124 can transmit the location information signal to a location server (not shown in FIG. 1). The location information signal transmitted to the location server can include a MAC address or other identifier for the location tag transceiver 120. The transmission to the location server can be a wireless communication directly to the location server or through a wireless local area network (WLAN) or wireless wide area network (WWAN) connection.

The low energy transceiver module 122 and the LAN transceiver module 124 can be configured to communicate via different radio access technologies (RATs). The low energy transceiver module can be configured to communicate via a first RAT including one or more of Bluetooth v4.0, Bluetooth Low Energy, Bluetooth v4.1, Bluetooth v4.2, or another low power/energy RAT standard. The LAN transceiver module can be configured to communicate via a second RAT including one or more of UHF, 3GPP LTE, IEEE 802.11a, IEEE 802.11b, IEEE 802.11g, IEEE 802.11n, IEEE 802.11ac, or IEEE 802.11ad.

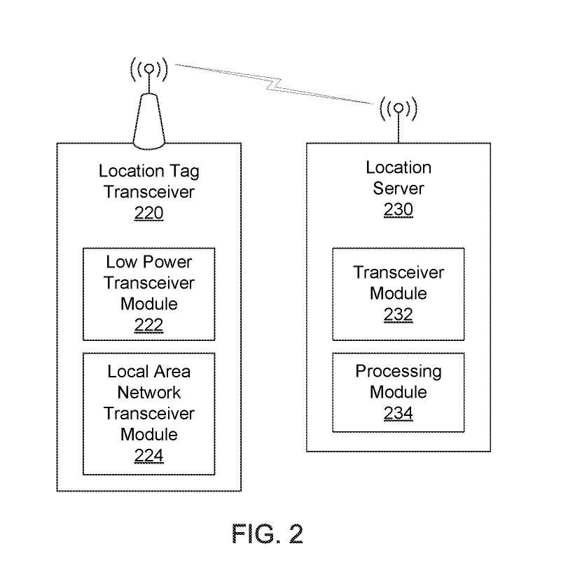

FIG. 2 illustrates an example of a location tag transceiver 220 and an example location server 230. The location server 230 can include a transceiver module 232 and a processing module 234. The transceiver module 234 can communicate using at least the same wireless communication standards as the low energy transceiver module 222 of the location tag transceiver 220. The transceiver module 232 can be configured to communicate using the same frequencies as the low energy transceiver module 222. The transceiver module 204 can receive a location information signal or location information from the location tag transceiver 220.

The processing module 234 can be configured to identify a fixed location perimeter of a low energy fixed location beacon (not shown). In other words, the processing module 234 can be configured to associate the location information signal with a fixed location perimeter of the low energy fixed location beacon. The fixed location perimeter can be identified based on a predetermined geographic location associated with the location information signal. The predetermined geographic location of each low energy fixed location beacon can be the physical location of the low energy fixed location beacon in the mine or underground complex and can be stored in the processing module 234. The predetermined geographic area can include the location of the low energy fixed location beacon placed along an edge of a room, enclosure, hallway, mine shaft, mine entry, drift (i.e., a nearly horizontal mine passageway), heading, tunnel, etc. The processing module 234 can determine a location of the location tag transceiver 220, within the fixed location perimeter, based on the power level of the received location information signal. The power level of the received location information signal can be the RSSI value of the location information signal at which it was received by the location tag transceiver 220.

The processing module 234 can be configured to store the status information from the location information signal. The status information can be used to update a record of sensor readings, and battery levels. The location of a location tag transceiver can be stored.

In one configuration, the processing module 234 can be configured to plot the location of the location tag transceiver 220, within the fixed location perimeter, on a scalable map. The scalable map can be an electronic map or diagram of a building, complex, underground complex or mine. The scalable map can be updated automatically or manually to reflect changes in the layout of a diagram or map. The scalable map can be updated automatically or manually to display the location of a location tag transceiver 220 within a building, complex, or mine.

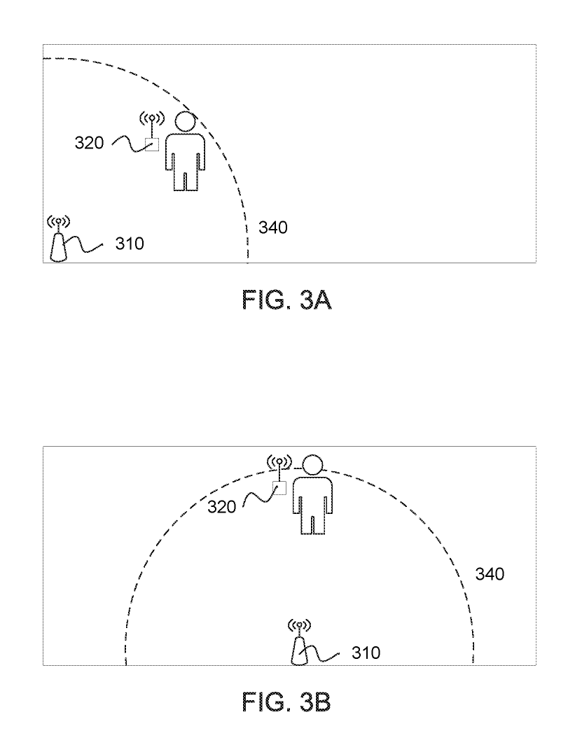

FIG. 3A illustrates tracking a location tag transceiver 320 with a low energy fixed location beacon 310. In one embodiment, a low energy fixed location beacon 310 can be placed in the corner of a room, enclosure, hallway, mine shaft, mine entry, drift, heading, tunnel, etc. The location tag transceiver 320 can receive a location information signal from the low energy fixed location beacon 310. The location tag transceiver 320 can transmit the location information signal to a location server (not shown). The location server can identify a fixed location perimeter 340 based on the location information signal. The fixed location perimeter 340 can be the range of the low energy fixed location beacon 310 as defined by a minimum signal strength. An example of the minimum signal strength can be −90 dBm. The location perimeter 340 can be defined by a room or enclosure. Examples of such rooms or enclosures can be mine shafts, hospital rooms, prison cells, residential living areas, and commercial offices, mine entries, drifts, tunnels, etc.

In one example, the low energy fixed location beacon 310 can be positioned along an edge of a room, enclosure, hallway, mine shaft, mine entry, drift, heading, tunnel, etc. The location of the location tag transceiver 320 can be determined by the location server to be anywhere within the fixed location perimeter 340 associated with the low energy fixed location beacon 310. In this example, by placing the low energy fixed location beacon 310 on the edge of the fixed location perimeter, the location of the location tag transceiver 320 can be narrowed to a smaller subsection of the possible fixed location perimeter. In other words, by positioning the low energy fixed location beacon along an edge of a room or fixed location perimeter, the location of the location tag transceiver can be more accurate by eliminating unlikely or impossible locations for the location tag transceiver 320.

In another configuration, the location of a location tag transceiver 320 can be more accurately defined within a fixed location perimeter by using the power level that the location information signal was received at by the location tag transceiver 320. The power level can be the RSSI value of the location information signal as received by the location tag transceiver 320.

FIG. 3B illustrates determining the position of a location tag transceiver 320 with a low energy fixed location beacon 310. In one embodiment, a low energy fixed location can be placed in the middle of a room, enclosure, hallway, mine shaft, mine entry, drift, heading, tunnel, etc. The location of the location tag transceiver 320 can be determined by the location server (not shown) to be anywhere within the fixed location perimeter 340 associated with the low energy fixed location beacon 310.

In another configuration, the location of a location tag transceiver 320 can be more accurately defined within a fixed location perimeter 340 by using the power level that the location information signal was received at by the location tag transceiver 320. The power level can be the RSSI value of the location information signal as received by the location tag transceiver 320.

In another configuration, the location of a location tag transceiver 320 can be more accurately defined within a fixed location perimeter 340 by using the power level at which the location information signal was received by the location server from the location tag transceiver 320. The power level can be the power level communicated to the WLAN or WWAN beacon from the location tag transceiver 320. The location information signal and the associated power level at which it was received by the WLAN or WWAN beaconcan be transmitted or reported to the location server. The power level can be the RSSI value at which the location information signal was communicated to the location server by the WLAN or WWAN beacon.

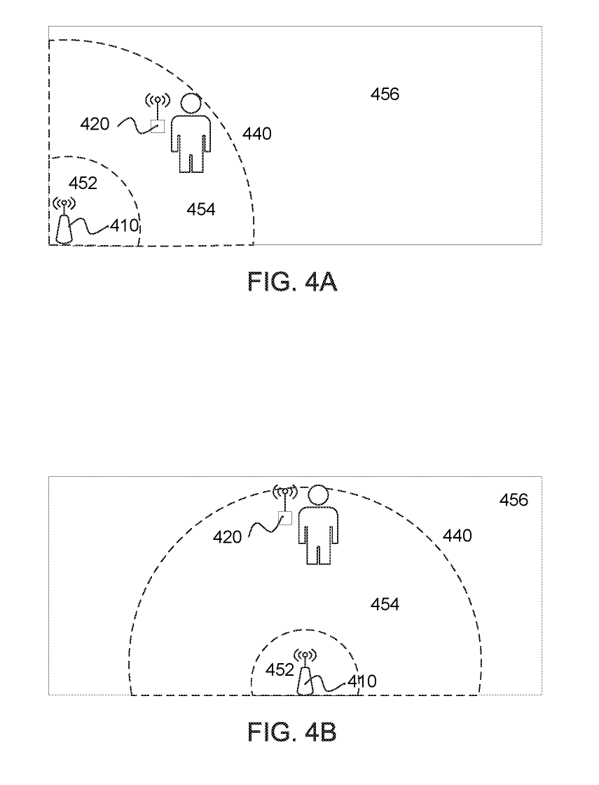

FIG. 4A illustrates determining the position of a location tag transceiver 420 with a low energy fixed location beacon 410 using one or more of Bluetooth v4.0, Bluetooth Low Energy, Bluetooth v4.1, or Bluetooth v4.2 wireless communication standards. In one embodiment, the low energy fixed location beacon 410 can be placed in the corner of a room, enclosure, hallway, mine shaft, mine entry, drift, heading, tunnel, etc. The location tag transceiver 420 can receive a location information signal from the low energy fixed location beacon 410 using one or more of Bluetooth v4.0, Bluetooth Low Energy, Bluetooth v4.1, or Bluetooth v4.2 wireless communication standards. The location tag transceiver can receive the location information signal without pairing with the low energy fixed location beacon 410. The location tag transceiver 420 can transmit the location information signal to a location server (not shown). This location information signal can include the MAC address of the low energy fixed location beacon 410. A location server (not shown) can identify a fixed location perimeter 440 associated with the predetermined geographic location of the low energy fixed location beacon 410 based on the MAC address of the low energy fixed location beacon 410.

In another configuration, the location of a location tag transceiver 420 can be more accurately defined within a fixed location perimeter 440 by using the power level that the location information signal was received at by the location tag transceiver. The location information signal can be received by the location tag transceiver at a first power level or first Bluetooth power level, a second power level or second Bluetooth power level, or a third power level or third Bluetooth power level.

A first power level can represent a power level or range of power levels associated with an immediate distance 452 between the low energy fixed location beacon 410 and the location tag transceiver 420. An example of the immediate distance 452 can be a distance of less than 1 meter between the location tag transceiver 420 and the low energy fixed location beacon 410.

A second power level can represent a power level or range of power levels associated with a near distance 454 between the low energy fixed location beacon 410 and the location tag transceiver 420. An example of the near distance 454 can be between 1 and 10 meters between the location tag transceiver 420 and the low energy fixed location beacon 410.

A third power level can represent a power level or range of power levels associated with a far distance 456 between the low energy fixed location beacon 410 and the location tag transceiver 420. An example of the far distance 456 can be greater than 10 meters between the location tag transceiver 420 and the low energy fixed location beacon 410.

These distances are not intended to be limiting. The actual distance can be set based on a power level of the transmitter and a sensitivity of the receiver, among other factors.

The limit of the far distance 456 can be the edge of the range of communication between the location tag transceiver 420 and the low energy fixed location beacon 410. In other words, the far distance 456 can be limited to the furthest distance that the location tag transceiver 420 and the low energy fixed location beacon 410 can communicate. An example of this furthest distance can be when the signal strength between the location tag transceiver 420 and the low energy fixed location beacon 410 is at or below the radio frequency noise level. An example of this signal strength can be −90 dBm.

The first, second, and third power levels can be the RSSI values of the location information signal as received by the location tag transceiver 420. Each distance and power level listed above is not intended to be limiting. Each distance and power level can be reduced by radio frequency interference or other obstacles.

FIG. 4B illustrates determining the position of a location tag transceiver 420 with a low energy fixed location beacon 410 using one or more of Bluetooth v4.0, Bluetooth Low Energy, Bluetooth v4.1, or Bluetooth v4.2 wireless communication standards. In one embodiment, the low energy fixed location beacon 410 can be placed in the middle of a room, enclosure, hallway, mine shaft, mine entry, drift, heading, tunnel, etc. The location tag transceiver 420 can receive a location information signal from the low energy fixed location beacon 410. The location tag transceiver 420 can transmit the location information signal to a location server (not shown). This location information signal can include the MAC address of the low energy fixed location beacon 410. The location server 202 can identify a fixed location perimeter 440 associated with the predetermined geographic location of the low energy fixed location beacon 410 based on the MAC address of the low energy fixed location beacon 410. The location information signal can be received by the location tag transceiver 420 at a first power level, a second power level, or a third power level. The first power level can be associated with the immediate distances 452 from the low power fixed location beacon 410. The second power level can be associated with the near distances 454 from each low energy fixed location beacon 410. The third power level can be associated with the far distances 440 from each low energy fixed location beacon 410.

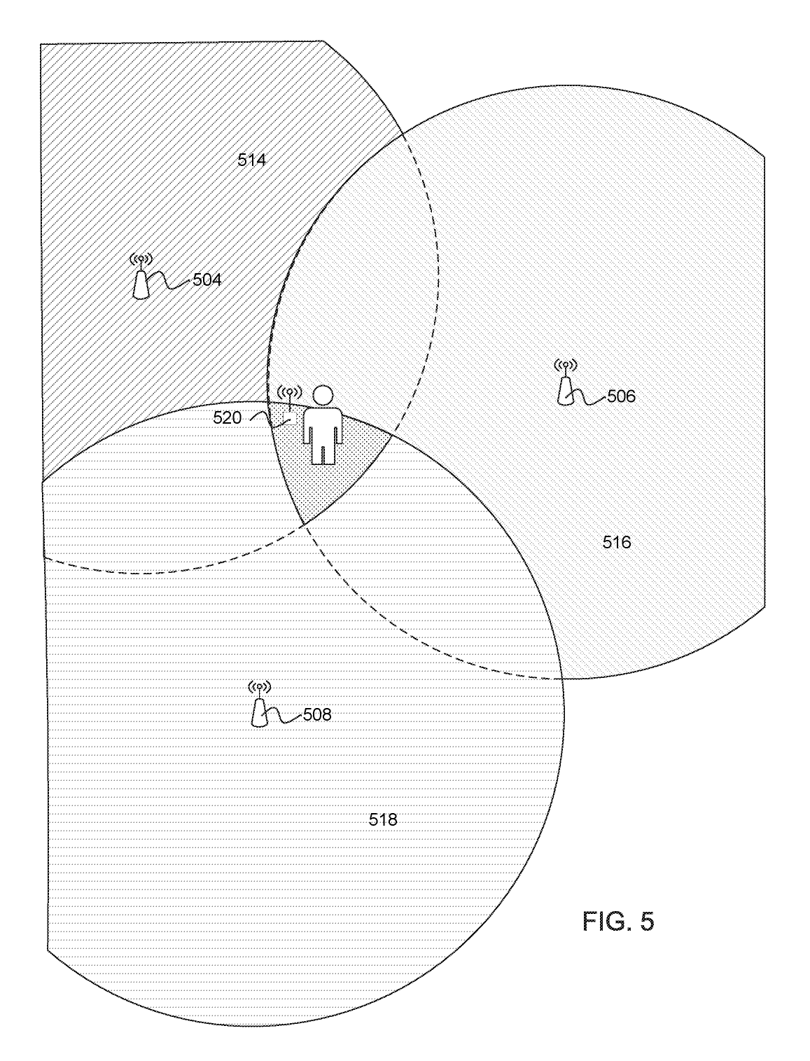

FIG. 5 illustrates determining the location of a location tag transceiver 520 based on communication between the location tag transceiver 520 and multiple low energy fixed location beacons 504, 506, 508. In one configuration, the location tag transceiver 520 can receive multiple location information signals from the multiple low energy fixed location beacons 504, 506, 508. The location tag transceiver 520 can transmit the location information signals from each low energy fixed location beacon to a location server (not shown). The location server can identify the fixed location perimeter 514, 516, 518 for each low energy fixed location beacon 504, 506, 508, respectively, based on a predetermined geographic location associated with the MAC address of each low energy fixed location beacon 504, 506, 508. The location server can determine a location of the location tag transceiver 520, within the multiple fixed location perimeters 514, 516, 518, based on the intersection of the fixed location perimeters 514, 516, 518 associated with the low energy fixed location beacons 504, 506, 508.

In another configuration, the location server can determine the location of the location tag transceiver 520, within the intersection of each fixed location perimeter 514, 516, 518, based on the power levels of each received location information signal. In other words, the location of a location tag transceiver 520 can be more accurately defined within the intersection of the fixed location perimeters 514, 516, 518 by using the power levels that the location information signals were received at by the location tag transceiver 520. The power levels can be the RSSI values of each location information signal as received by the location tag transceiver 520.

In one configuration, the location of the location tag transceiver 520 can be determined based on communication between the location tag transceiver 520 and multiple low energy fixed location beacons 504, 506, 508 using one or more of Bluetooth v4.0, Bluetooth Low Energy, Bluetooth v4.1, or Bluetooth v4.2 wireless communication standards. In one configuration, the location tag transceiver 520 can receive multiple location information signals from multiple low energy fixed location beacons 504, 506, 508 using one or more of Bluetooth v4.0, Bluetooth Low Energy, Bluetooth v4.1, or Bluetooth v4.2 wireless communication standards. The location server can determine a location of the location tag transceiver 520, within the multiple fixed location perimeters 514, 516, 518 based on the intersection of the fixed location perimeters 514, 516, 518 associated with the low energy fixed location beacons 504, 506, 508. The location of a location tag transceiver 520 can be more accurately defined within the intersection by using the power levels that the location information signals were received at by the location tag transceiver 520. The location information signals can be received by the location tag transceiver 520 at a first power level, a second power level, or a third power level. The first power level can be associated with immediate distances between the location tag transceiver 520 and each respective low energy fixed location beacon 504, 506, 508. The second power level can be associated with near distances between the location tag transceiver 520 and each respective low energy fixed location beacon 504, 506, 508. The third power level can be associated with far distances between the location tag transceiver 520 and each respective low energy fixed location beacon 504, 506, 508.

In one configuration, the location server can determine the location of the location tag transceiver 520 based on communication between the location tag transceiver 520 and multiple low lower fixed location beacons 504, 506, 508. An RSSI of each low power fixed location beacon 504, 506, 508 and a combination and intersection of all low energy fixed location beacons 504, 506, 508 (which can be present at any given point) can be pre-mapped and stored on the location server. The RSSI of each low energy fixed location beacon 504, 506, 508 can be pre-mapped and stored as a radio frequency (RF) signature for a plurality of locations in the building, mine, etc. as a unique intersection of RSSI values for the low energy fixed location beacons 504, 506, 508. In other words, the location server can determine the location of the location tag transceiver 520 based on a pre-defined map of RSSI values that are present at any given location from all low energy fixed location beacons 504, 506, 508 in proximity to the location tag transceiver 520. This RF map can be used to provide accurate locations of the location tag transceiver 520 in areas where RSSI decay is non-linear and may be experiencing reflection and/or amplification from interaction with surrounding environmental materials including other RF energy. Therefore, the predefined map of RSSI values for the low energy fixed location beacons 504, 506, 508 can be used to improve location tracking accuracy when determining the location of the location tag transceiver 520.

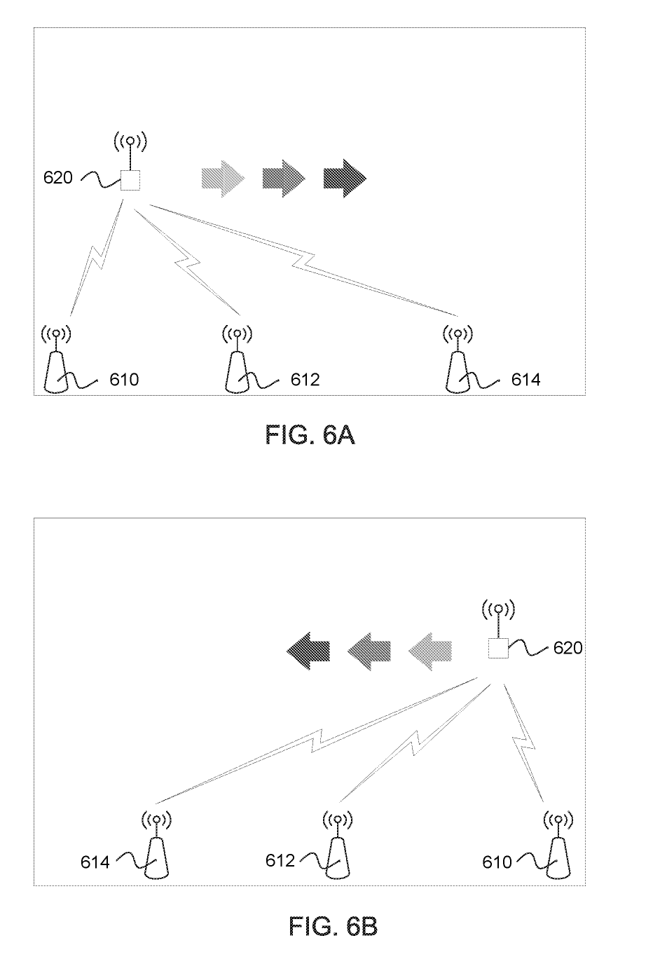

FIGS. 6A and 6B illustrate determining a location tag transceiver's direction of travel based on communications between low energy fixed location beacons 610, 612, 614 and the location tag transceiver 620. The low energy fixed location beacons 610, 612, 614 can transmit multiple location information signals to the location tag transceiver 620. The location tag transceiver 620 can receive multiple location information signals. Each location information signal can have a power level at which it was received by the location tag transceiver 620. The location tag transceiver 620 can transmit the multiple location information signals to a location server (not shown). The location server can determine a direction of travel of the location tag transceiver 620 within the fixed location perimeter based on the multiple information signals and the power level of each location information signal as received by the location tag transceiver 620.

In one example, as shown in FIG. 6A, the location server can determine a direction of travel of a location tag transceiver 620 based on multiple location information signals received from the low energy fixed location beacons 610, 612, 614. The location tag transceiver 620 can be travelling toward the low energy fixed location beacon 614. The power levels of the location information signals can increase as the location tag transceiver 620 approaches the low energy fixed location beacon 614. The location server can determine that based on the increasing power levels of the location information signals, the location tag transceiver 620 is travelling in a direction toward the low energy fixed location beacon 614. In other words, the location server can determine the direction of travel based on a time sequencing of RSSI from the low energy fixed location beacons 610, 612, 614.

In an alternative example, as shown in FIG. 6B, the location server can determine a direction of travel of a location tag transceiver 620 based on multiple location information signals received from the low energy fixed location beacons 610, 612, 614. The location tag transceiver 620 can be travelling away from the low energy fixed location beacons 610. The power levels of the location information signals can decreases as the location tag transceiver 620 moves away from the low energy fixed location beacon 610. The location server can determine that based on the decreasing power levels of the location information signals, the location tag transceiver 620 is travelling in a direction away from the low energy fixed location beacon 610. In other words, the location server can determine the direction of travel based on a time sequencing of RSSI from the low energy fixed location beacons 610, 612, 614.

In another example, the location tag transceiver 620 can be travelling between a first low energy fixed location beacon and a second low energy fixed location beacon. The location server can determine the direction of travel by comparing the power levels of multiple location information signals received from the multiple low energy fixed location beacons. In other words, as the location tag transceiver 620 travels past a first low energy fixed location beacon and approaches a second low energy fixed location beacon, the power levels for the location information signals received from the first low energy fixed location beacon will decrease and the power levels of the location information signal received from the second low energy fixed location beacon will increase.

In another configuration, the location server can determine the direction of travel of the location tag transceiver 620 by comparing the power levels at which the location information signal is received from the location tag transceiver 620. In other words, the location server can determine the direction of travel based on the power levels at which each location information signal was received from the location tag transceiver 620.

In another configuration, the location server can determine the direction of travel of the location tag transceiver 620 based on both the power levels at which the location information signal was received by the location tag transceiver 620 from the low energy fixed location beacon 610 and the power levels which are transmitted from the location tag transceiver 620 to the location server. The power levels at which the location information signals were received by the location server from the location tag transceiver 620, can be the power levels at which a WLAN or WWAN beacon, connected to the location server, received the location information signal from the location tag transceiver 620. The location information signals and the associated power levels at which they were received by the WLAN or WWAN beacon can be transmitted or reported to the location server.

In one configuration, a tracking system, such as a Bluetooth Low Energy (BLE) tracking system, can utilize low energy fixed location beacons (or BLE beacons at fixed reference points) in a mine or building. When a location tag transceiver (also referred to as a tracking tag or a computing device) is close enough to a specific low energy fixed location node to detect a beacon's MAC address, a location server can make an association between the location tag transceiver and the low energy fixed location node. More specifically, an application that executes on the location server can make the association between the location tag transceiver and the low energy fixed location beacon. In addition, the location server can place the location tag transceiver on a tracking map in proximity of the low energy fixed location node. In general, the location tag transceiver is in proximity (e.g., ±approximately 50 feet) to the low energy fixed location beacon when the location tag transceiver is able to detect the MAC address of the low energy fixed location beacon.

In one configuration, a wanderer or secondary tracking system is an extension to the low energy tracking system described above. The wanderer or secondary tracking system can utilize the same principle of proximity as compared to the low energy tracking system. In other words, the wanderer or secondary tracking system also operates when the location tag transceiver is in proximity (e.g., 50 feet or less) to a low energy beacon to detect the MAC address.

However, one difference is that a special class of low energy beacons can be designated as “wanderer beacons” to be tracked instead of being used as fixed reference points (as described in the above tracking system). These low energy beacons can be designated via their MAC addresses. When the location tag transceiver detects a low energy beacon that has been registered with the location server as a wanderer beacon, the location server determines that the low energy beacon is not to be used as a reference point to help locate the location tag transceiver on the tracking map. Rather, the location server can locate the position of the wanderer node in relation to the location tag transceiver. The wanderer beacon may travel between various locations. In other words, the wanderer beacon may not be at a fixed location. The location server has already established an approximate location of the location tag transceiver based on interactions with other low energy fixed location beacons in the vicinity. Therefore, the location server can assign a “secondary” location to the wanderer beacon based on an assumed proximity of the wanderer beacon to the location tag transceiver.

In one example, the wanderer beacon can be associated with a pre-surveyed position on a map. The location tag transceiver can detect a wanderer beacon and transmit a MAC address associated with the detected wanderer beacon to the location server. When the wanderer beacon is detected by the location tag transceiver, the location server can associate a position of the wanderer beacon (as detected using the MAC address associated with the wanderer beacon) with a position of the location tag transceiver that detected the wanderer beacon and at a time of detection.

In one example, the location assigned to the wanderer beacon is referred to as a “secondary” location. The secondary location can be refined by centering the secondary location on a range of positions detected by the location tag transceiver, thereby providing the secondary location of the wanderer beacon. The location of the wanderer beacon can be secondary since the location of the location tag transceiver can be located approximately 50 feet from the position of the nearby fixed location low energy beacons, and the wanderer node can be detected a defined number of feet from an assumed position of the location tag transceiver, thereby providing a worst case location geometry of approximately 100 feet.

In one example, when the wanderer beacon is located on the tracking map by the location server, the wanderer beacon is placed within an approximately 50 foot radius of the location tag transceiver that reported a detection of the wanderer beacon's MAC address. Since the location tag transceiver is located within an approximately 50 foot radius of a low energy fixed location beacon (or BLE beacon) with a known (surveyed) location, the wanderer beacon may be located within a 100 foot radius from the low energy fixed location beacon with the surveyed location. Although the location of the wanderer beacon can be up to 100 feet from the low energy fixed location beacon, this level of accuracy can be adequate to locate equipment, particularly if the beacon seldom moves or is parked for relatively long periods of time. In addition, a search of a 100 foot radius can turn up the equipment with minimum time lost.

In one example, this mode can be useful because an important pallet of materials destined to be stored underground or somewhere on a portal deck can be located for approximately 10 years with the small investment of a low power/energy node (or BLE beacon). The process of placing the low energy node on a pallet of supplies or a piece of equipment is relatively straightforward. In addition, with respect to the wanderer or secondary tracking system, the location server can keep track of the location tag transceiver (and a person who moved or is moving the equipment with the location tag transceiver). In other words, equipment and pallets of supplies do not move themselves, and each time the equipment and/or pallets of supplies are moved, a person with the location tag transceiver is performing the moving. The location server can use the location of the person's location tag transceiver to locate the wanderer beacon. When the wander beacon is parked or immobile, the location server can store a last location, assign the last location as a current location, and record a date/time at which the wanderer beacon was last moved and an identity of the person that parked the wanderer beacon. The ability to gather this information is useful to improve operational efficiency.

In one configuration, a range of the wanderer or secondary tracking system can be extended outside a wireless local area network (WLAN). As previously described, the wanderer or secondary tracking system involves a location tag transceiver detecting the low energy beacon, and then transmitting a detected MAC address to the location server over the LAN. In this configuration, the location tag transceiver can execute software that utilizes a local buffer to store time stamped MAC addresses from both low energy fixed location beacons and wanderer beacons (i.e., low energy non-fixed location beacons) that are located outside of the WLAN network coverage area. The time stamped MAC addresses can be stored in the buffer when the location tag transceiver exits a boundary of the WLAN. For example, the time stamped MAC addresses can be stored in the buffer when a user carrying the location tag transceiver travels to a location (e.g., a particular room, enclosure, hallway, mine shaft, mine entry, drift, heading or tunnel) that is outside the boundary of the WLAN. This buffered data (i.e., the time stamped MAC addresses) can be uploaded at an earliest opportunity or when the location tag transceiver returns to within the WLAN. This allows for determination of the wanderer beacon's location outside the WLAN (e.g., Wi-Fi corridor), which may include every nook and cranny of a mine, although the location may not be determined in real time. However, this may not be an issue because items stored in the hinterlands of mines may not need real time location determination. For example, a 5, 10, 15, or even 60 minute delay in reporting their locations can be acceptable, which can also allow for low cost asset tracking coverage of an entire area, such as a mine.

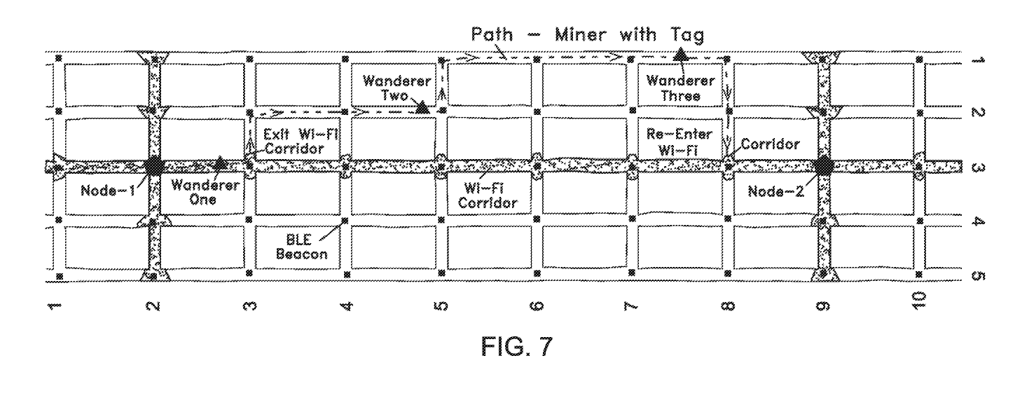

FIG. 7 illustrates an example of various entities included in a tracking system, and in particular, a wanderer or secondary tracking system that is extended outside a wireless local area network (WLAN). As previously discussed, a location tag transceiver can use a local buffer to store time stamped MAC addresses from both low energy fixed location beacons and wanderer beacons. The time stamped MAC addresses can be stored in the buffer when the location tag transceiver exits a boundary of the WLAN. This buffered data (i.e., the time stamped MAC addresses) can be uploaded at an earliest opportunity or when the location tag transceiver returns to within the WLAN. This allows for determination of the wanderer beacon's location outside the WLAN (e.g., Wi-Fi corridor).

As shown in FIG. 7, a location tag transceiver can travel within a particular area (e.g., a mine). The location tag transceiver can initially be within the boundary of the WLAN. The location tag transceiver can upload a location of a first wanderer beacon to a tracking server upon the location tag transceiver detecting the first wanderer beacon. At some point later in time, the location tag transceiver can travel outside the boundary of the WLAN. During this time, the location tag transceiver can store time stamped MAC addresses from all of the fixed location beacons encountered and for the second wanderer beacon and the third wanderer beacon in a local buffer. The local buffer can store time stamped MAC addresses for the fixed location beacons, as well as time stamped MAC addresses of the wanderer beacons in order to provide sufficient information to the tracking server to locate the wanderer beacons. When the location tag transceiver reenters the boundary of the WLAN, the location tag transceiver can upload the time stamped MAC addresses from the local buffer to the location tracking server.

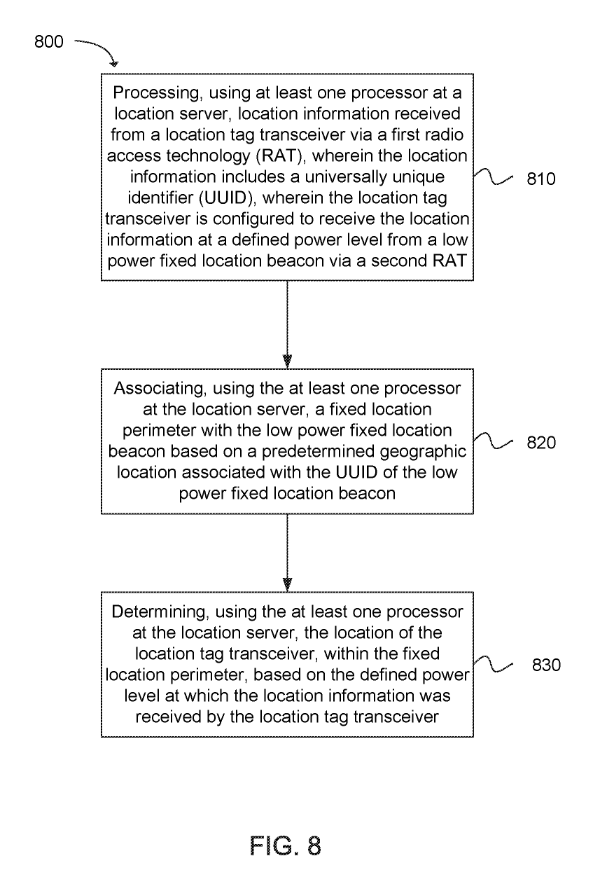

Another example provides at least one machine readable storage medium having instructions 800 embodied thereon for determining a location of a location tag transceiver, as shown in FIG. 8. The instructions can be executed on a machine, where the instructions are included on at least one computer readable medium or one non-transitory machine readable storage medium. The instructions when executed perform: processing, using at least one processor at a location server, location information MAC address received from a location tag transceiver via a first radio access technology (RAT), wherein the location information includes a media access control (MAC address), wherein the location tag transceiver is configured to receive the location information at a defined power level from a low power fixed location beacon via a second RAT, as in block 810. The instructions when executed perform: associating, using the at least one processor at the location server, a fixed location perimeter with the low energy fixed location beacon based on a predetermined geographic location associated with the MAC address of the low energy fixed location beacon, as in block 820. The instructions when executed perform: determining, using the at least one processor at the location server, the location of the location tag transceiver, within the fixed location perimeter, based on the defined power level at which the MAC address location information was received by the location tag transceiver, as in block 830.

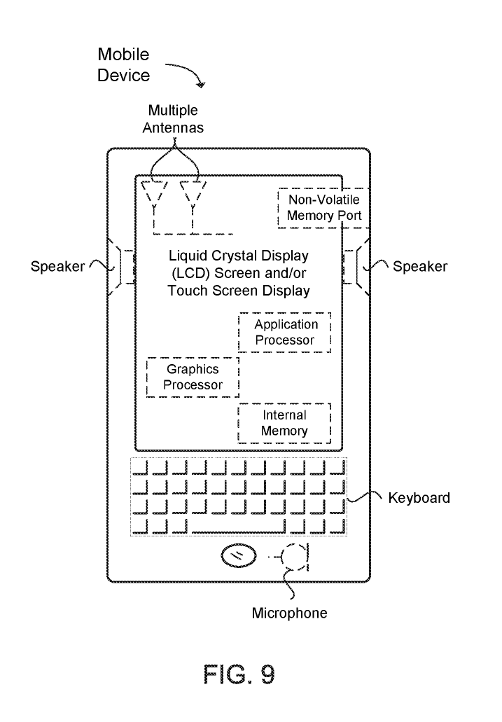

FIG. 9 provides an example illustration of the location tag transceiver, such as a user equipment (UE), a mobile station (MS), a mobile wireless device, a mobile communication device, a tablet, a handset, a wireless transceiver coupled to a processor, or other type of wireless device. In one example, the location tag transceiver can operate using an Android® or iOS® operating system. The location tag transceiver can include one or more antennas configured to communicate with a beacon or node or transmission station, such as an access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The location tag transceiver can communicate using separate antennas for each wireless communication standard or shared antennas for multiple wireless communication standards. The location tag transceiver can communicate in a wireless local area network (WLAN), a wireless personal area network (WPAN), and/or a WWAN.

FIG. 9 also provides an illustration of a microphone and one or more speakers that can be used for audio input and output from the location tag transceiver. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the location tag transceiver. A keyboard can be integrated with the location tag transceiver or wirelessly connected to the location tag transceiver to provide additional user input. A virtual keyboard can also be provided using the touch screen.

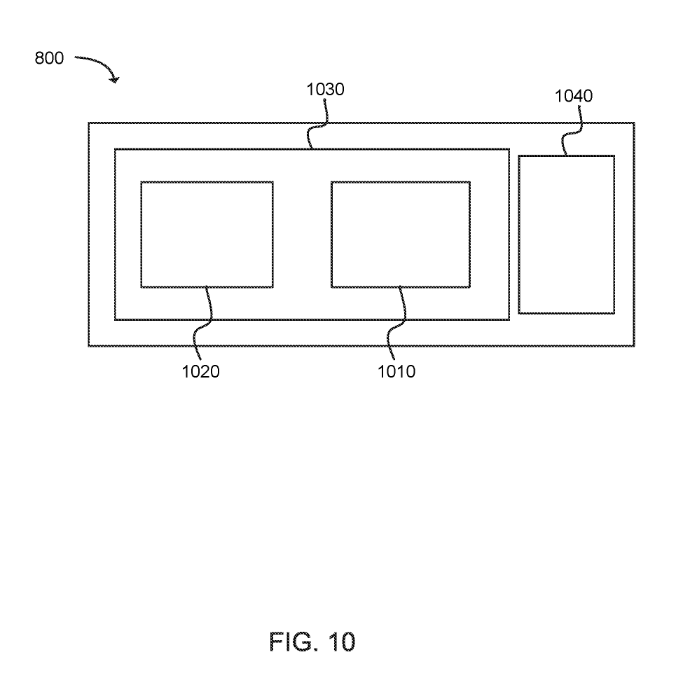

FIG. 10 provides an example illustration of a compact location tag transceiver 1000. In this example, the location tag transceiver can comprise a circuit board 1030, such as a printed circuit board (PCB), with a BLE transceiver 1010 and a Wi-Fi transceiver 1020. The PCB can also include one or more digital processors and memory configured to operate with the transceivers, as discussed in the preceding paragraphs. Each transceiver 1010, 1020 can also include a baseband processor configured to operate with the transceivers to transmit and receive data. The PCB in this example can have approximate dimensions of 1.75 inches×0.75 inches by 0.15 inches. The PCB can be configured to connect with a battery 1040.

The compact location tag 1000 can be shaped to fit within a desired compartment, such as a miners cap lamp or another desired location. This example is not intended to be limiting. The shape and size of the circuit board and the transceivers can depend on system requirements such as power consumption, operating distance, antenna size, and so forth.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. The low energy fixed location beacon, location tag transceiver, and location server can also include a transceiver module (i.e., transceiver), a counter module (i.e., counter), a processing module (i.e., processor), and/or a clock module (i.e., clock) or timer module (i.e., timer). One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A location tag transceiver configured to enable location information services, the location tag transceiver comprising:
a low energy transceiver module configured to receive a location information signal MAC address from a low energy fixed location beacon via a first radio access technology (RAT), wherein the location information signal includes a media access control (MAC) at a defined power level; and
a local area network (LAN) transceiver module configured to transmit, via a second RAT, the location information signal to a location server to enable the location server to:
identify a fixed location perimeter of the low energy fixed location beacon based on a predetermined geographic location associated with the MAC; and
determine a location of the location tag transceiver, within the fixed location perimeter, based on the defined power level of the received location information signal.

2. The location tag transceiver of claim 1, wherein the location server is further configured to determine the location of the location tag transceiver based on a predefined map of power level values that are present at selected locations for a plurality of low energy fixed location beacons in proximity to the location tag transceiver.

3. The location tag transceiver of claim 1, wherein the predetermined geographic location includes a location of the low energy fixed location beacon along an edge of the fixed location perimeter to enable the location server to more accurately determine the location of the location tag based on the selected power level of the received location information signal.

4. The location tag transceiver of claim 1, wherein the location information signal includes status information, wherein the status information is one or more of a battery level, a pressure reading, a temperature reading, an air flow reading, a dust level or another type of monitoring data.

5. The location tag transceiver of claim 1, wherein:
the first RAT is one or more of Bluetooth v4.0, Bluetooth Low Energy, Bluetooth v4.1, or Bluetooth v4.2; and
the second RAT is one or more of Institute of Electrical and Electronics Engineers (IEEE) 802.11a, IEEE 802.11b, IEEE 802.11g, IEEE 802.11n, IEEE 802.11ac, IEEE 802.11ad, Ultra High Frequency (UHF), Very High Frequency (VHF), 3GPP, IEEE 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, or IEEE 802.16.1a-2013.

6. The location tag transceiver of claim 1, wherein the location of the location tag transceiver is determined based on:
the defined power level, wherein the defined power level represents one of an immediate distance, a near distance or a far distance between the low energy fixed location beacon at an edge of the fixed location perimeter and the location tag transceiver; or
a predefined map of power level values that are present at selected locations for a plurality of low energy fixed location beacons in proximity to the location tag transceiver, wherein the power level values include received strength signal indicator (RSSI) power values.

7. The location tag transceiver of claim 1, wherein the LAN transceiver module is configured to transmit a plurality of location information signals to the location server to enable the location server to determine a direction of travel of the location tag transceiver, within the fixed location perimeter, by comparing power levels associated with a plurality of received location information signals in a time sequence.

8. The location tag transceiver of claim 1, wherein the location tag transceiver is further configured to:
receive a plurality of location information signals from a plurality of low energy fixed location beacons; and
transmit the plurality of location information signals to the location server to enable the location server to:
identify the fixed location perimeter of each low energy fixed location beacon in the plurality of low energy fixed location beacons based on a predetermined geographic location associated with a MAC address of each of the plurality of low energy fixed location beacons; and
determine the location of the location tag transceiver, within the fixed location perimeter, based on an intersection of each fixed location perimeter associated with the plurality of low energy fixed location beacons and power levels of each received location information signal.

9. The location tag transceiver of claim 1, further comprising a processing module configured to:
detect time stamped media access control (MAC) addresses for low energy fixed location beacons and low energy non-fixed location beacons when the location tag transceiver is outside a boundary of a wireless local area network (WLAN);
store the time stamped MAC addresses in a local buffer of the location tag transceiver; and
upload the time stamped MAC addresses to the location server after the location tag transceiver travels within the boundary of the WLAN, wherein the location server is configured to determine the locations of the low energy non-fixed location beacons when the time stamped MAC addresses were detected at the location tag transceiver.

10. A location server configured to determine a location of a location tag transceiver, the location server comprising:
a transceiver module configured to receive, from the location tag transceiver, location information that includes a media access control (MAC address), wherein the location tag transceiver is configured to receive the location information at a defined power level from a low energy fixed location beacon; and
a processing module configured to:
associate a fixed location perimeter with the low energy fixed location beacon based on a predetermined geographic location associated with the MAC address of the low energy fixed location beacon; and
determine the location of the location tag transceiver, within the fixed location perimeter, based on the defined power level at which the location information was received by the location tag transceiver.

11. The location server of claim 10, wherein the processing module is further configured to plot the location of the location tag transceiver on a scalable map.

12. The location server of claim 10, wherein the predetermined geographic location includes a location of the low energy fixed location beacon along an edge of the fixed location perimeter to enable the location server to more accurately determine the location of the location tag based on the selected power level at which the location information was received by the location tag transceiver.

13. The location server of claim 10, wherein the location of the location tag transceiver is determined based on:
the defined power level, wherein the defined power level represents one of an immediate distance, a near distance or a far distance between the low energy fixed location beacon at an edge of the fixed location perimeter and the location tag transceiver; or
a predefined map of power level values that are present at selected locations for a plurality of low energy fixed location beacons in proximity to the location tag transceiver, wherein the power level values include received strength signal indicator (RSSI) power values.

14. The location server of claim 10, wherein the location server is further configured to:
receive a plurality of location information signals; and
determine a direction of travel of the location tag transceiver, within the fixed location perimeter, by comparing power levels of the plurality of received location information signals.

15. The location server of claim 10, wherein the location server is further configured to:
receive a plurality of location information signals from a plurality of low energy fixed location beacons;
identify the fixed location perimeter of each low energy fixed location beacon in the plurality of low energy fixed location beacons based on a predetermined geographic location associated with a MAC address of each of the plurality of low energy fixed location beacons; and
determine the location of the location tag transceiver, within the fixed location perimeter, based on an intersection of each fixed location perimeter associated with the plurality of low energy fixed location beacons and power levels of each received location information signal.

16. The location server of claim 10, wherein the processing module is further configured to:
receive, from the location tag transceiver, a media access control (MAC) address associated with a low energy non-fixed location beacon, wherein the location tag transceiver is configured to detect the MAC address associated with the low energy non-fixed location beacon;
associate the MAC address to a pre-surveyed location of the low energy non-fixed location beacon; and
determine the location of the location tag transceiver based on the pre-surveyed location of the low energy non-fixed location beacon.

17. At least one non-transitory machine readable storage medium having instructions embodied thereon for determining a location of a location tag transceiver, the instructions when executed perform the following:
processing, using at least one processor at a location server, location information received from a location tag transceiver via a first radio access technology (RAT), wherein the location information includes a media access control (MAC address), wherein the location tag transceiver is configured to receive the location information at a defined power level from a low energy fixed location beacon via a second RAT;
associating, using the at least one processor at the location server, a fixed location perimeter with the low energy fixed location beacon based on a predetermined geographic location associated with the MAC address of the low energy fixed location beacon; and
determining, using the at least one processor at the location server, the location of the location tag transceiver, within the fixed location perimeter, based on the defined power level at which the MAC address location information was received by the location tag transceiver.

18. The at least one non-transitory machine readable storage medium of claim 17, further comprising instructions when executed perform the following:
determining the location of the location tag transceiver based on a predefined map of power level values that are present at MAC address selected locations for a plurality of low energy fixed location beacons in MAC address proximity to the location tag transceiver.

19. The at least one non-transitory machine readable storage medium of claim 17, wherein:
the first RAT is one or more of Institute of Electrical and Electronics Engineers (IEEE) 802.11a, IEEE 802.11b, IEEE 802.11g, IEEE 802.11n, IEEE 802.11ac, IEEE 802.11ad, Ultra High Frequency (UHF), Very High Frequency (VHF), 3GPP, IEEE 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, or IEEE 802.16.1a-2013; and
the second RAT is one or more of Bluetooth v4.0, Bluetooth Low Energy, Bluetooth v4.1, or Bluetooth v4.2; and

20. The at least one non-transitory machine readable storage medium of claim 17, further comprising instructions when executed perform the following: plotting the location of the location tag transceiver on a scalable map.

21. The at least one non-transitory machine readable storage medium of claim 17, further comprising instructions when executed perform the following: determining the location of the location tag transceiver based on:
the defined power level, wherein the defined power level represents one of an immediate distance, a near distance or a far distance between the low energy fixed location beacon at an edge of the fixed location perimeter and the location tag transceiver; or
a predefined map of power level values that are present at selected locations for a plurality of low energy fixed location beacons in proximity to the location tag transceiver, wherein the power level values include received strength signal indicator (RSSI) power values.
